(19) United States
(12) Patent Application Publication
(10) Pub. No.: US 2013/0194173 A1
(43) Pub. Date: Aug. 1, 2013

(54) TOUCH FREE CONTROL OF ELECTRONIC SYSTEMS AND ASSOCIATED METHODS

(71) Applicants: Yanning Zhu, Snoqualmie, WA (US); Aleksey Fadeev, Seattle, WA (US)

(72) Inventors: Yanning Zhu, Snoqualmie, WA (US); Aleksey Fadeev, Seattle, WA (US)

(73) Assignee: INGEONIX CORPORATION, Snoqualmie, WA (US)

(21) Appl. No.: 13/363,569

(22) Filed: Feb. 1, 2012

(51) Int. Cl. G09G 5/00

(52) U.S. Cl. 345/156

(57) ABSTRACT

Various embodiments of electronic systems and associated methods of hands-free operation are described. In one embodiment, a method includes acquiring an image of a user's finger and/or an object associated with the user's finger with a camera, recognizing a gesture of the user's finger or the object based on the acquired image, and determining if the recognized gesture correlates to a command or a mode change for a processor. If the monitored gesture correlates to a command for a processor, the method includes determining if the processor is currently in a standby mode or in a control mode. If the processor is in the control mode, the method includes executing the command for the processor; otherwise, the method includes reverting to monitoring a gesture of the user's finger.

### BACKGROUND

Graphical user interfaces (“GUIs”) allow users to interact with electronic devices (e.g., computers and smart phones) based on images rather than text commands. For example, GUIs can represent information and/or actions available to users through graphical icons and visual indicators. Such representation is more intuitive and easier to operate than text-based interfaces, typed command labels, or text navigation.

To realize the advantages of GUIs, users typically utilize mice, touchscreens, touchpads, joysticks, and/or other human-machine interfaces (“HMIs”) to control and/or manipulate graphical icons and visual indicators. However, such HMIs may be difficult to operate. For example, a user must mentally translate planar two-dimensional movements of a mouse into those of a pointer on a computer display. In another example, touchpads and touchscreens can be even more difficult to operate than mice because of variations in touch sensitivity and/or limited operating surfaces. As a result, various hands-free techniques have been developed to operate electronic devices without HMIs. Examples of such hands-free techniques include voice recognition and camera-based head tracking. These conventional hands-free techniques, however, have limited functionalities and typically cannot replace conventional HMIs.

### BRIEF DESCRIPTION OF THE DRAWINGS

FIG. 1A is a schematic diagram of an electronic system with touch free control in accordance with embodiments of the present technology.

FIG. 1B is a schematic diagram of another electronic system with touch free control assisted by an input device in accordance with embodiments of the present technology.

FIG. 2 is a block diagram showing computing system software modules suitable for the system of FIG. 1A or 1B in accordance with embodiments of the present technology.

FIG. 3 is a block diagram showing software routines suitable for the process module of FIG. 2 in accordance with embodiments of the present technology.

FIG. 4A is a flowchart showing a process of touch free control in accordance with embodiments of the present technology.

FIG. 4B is a flowchart showing a process of monitoring a user's finger in accordance with embodiments of the present technology.

FIG. 5 is a block diagram illustrating transition of control modes in accordance with embodiments of the present technology.

FIG. 6 is a schematic spatial diagram illustrating a move gesture in accordance with embodiments of the present technology.

FIGS. 7A-C are schematic spatial diagrams illustrating move initialization gestures in accordance with embodiments of the present technology.

FIGS. 8A-C are schematic spatial diagrams illustrating virtual touch initialization gestures in accordance with embodiments of the present technology.

FIGS. 9A-D are schematic spatial diagrams illustrating command initialization gestures in accordance with embodiments of the present technology.

FIGS. 10A-C are schematic spatial diagrams illustrating additional gestures in accordance with embodiments of the present technology.

FIGS. 11A-C are schematic spatial diagrams illustrating further gestures in accordance with embodiments of the present technology.

FIGS. 12A and 12B are schematic spatial diagrams illustrating rotation gestures in accordance with embodiments of the present technology.

### DETAILED DESCRIPTION

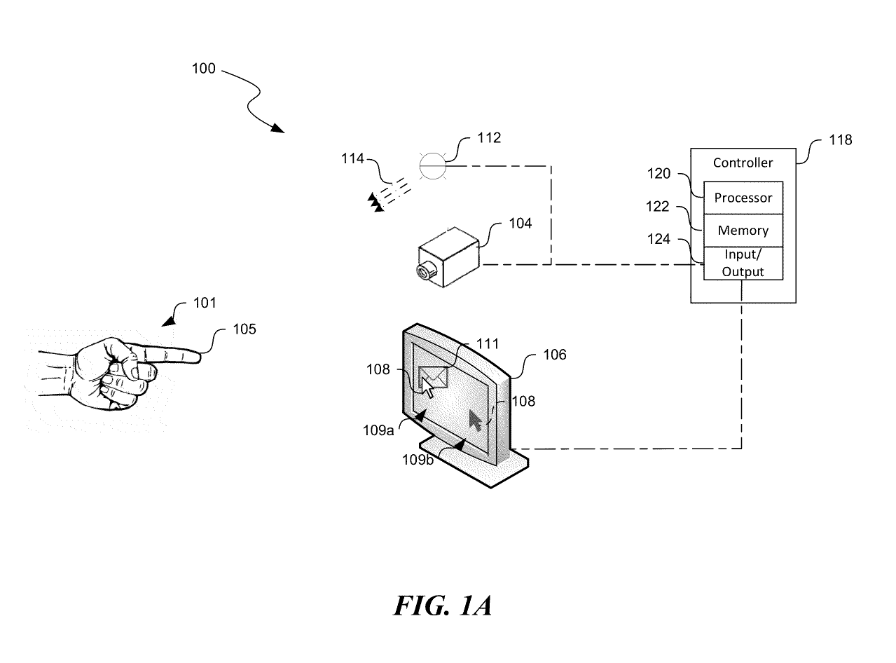

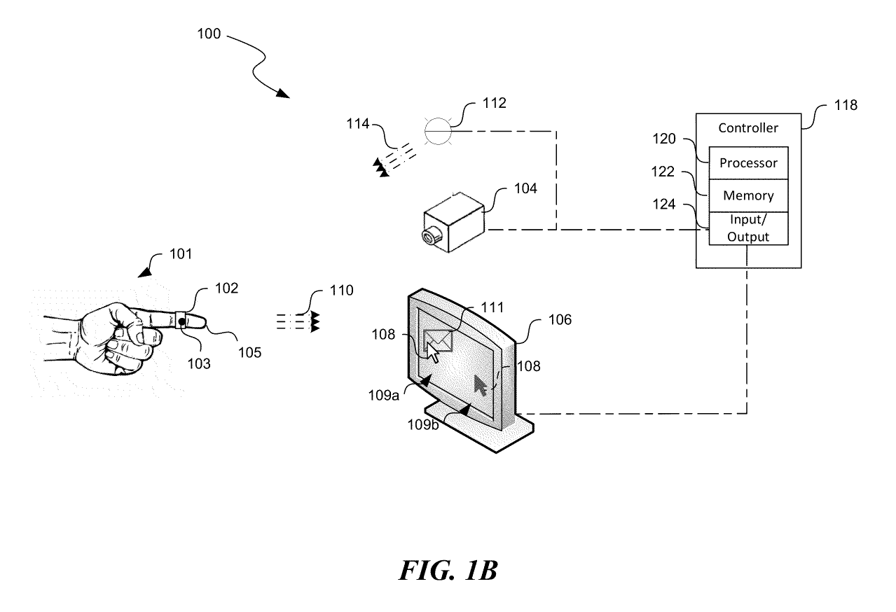

Various embodiments of electronic systems, devices, and associated methods of hands-free operation are described below. The term “gesture” as used herein generally refers to a representation or expression based on a position, an orientation, and/or a temporal movement trajectory of a finger, a hand, other parts of a user, and/or an object associated therewith. For example, a gesture can include a user's finger holding a generally static position (e.g., canted position) relative to a reference point or plane. In another example, a gesture can include a user's finger moving toward or away from a reference point or plane over a period of time. In further examples, a gesture can include a combination of static and dynamic representations and/or expressions. A person skilled in the relevant art will also understand that the technology may have additional embodiments, and that the technology may be practiced without several of the details of the embodiments described below with reference to FIGS. 1A-12B.

FIG. 1A is a schematic diagram of an electronic system 100 with touch free control in accordance with embodiments of the present technology. As shown in FIG. 1A, the electronic system 100 can include a detector 104, an output device 106, and a controller 118 operatively coupled to one another. Optionally, the electronic system 100 can also include an illumination source 112 (e.g., a fluorescent light bulb, a light emitting diode (“LED”), etc.) configured to provide illumination 114 to a finger 105 of a user 101 and/or other suitable components of the electronic system 100.

In the illustrated embodiment, the finger 105 is shown as an index finger on a left hand of the user 101. In other embodiments, the finger 105 can also be other suitable finger on either left or right hand of the user 101. Even though the electronic system 100 is described below as being configured to monitor only the finger 105, in further embodiments, the electronic system 100 can also be configured to monitor two, three, or any suitable number of fingers of the user 101 on left and/or right hands of the user 101. In yet further embodiments, the electronic system 100 can also be configured to monitor at least one object (e.g., an input device 102 in FIG. 1B) associated with the finger 105, as described in more detail below with reference to FIG. 1B.

The detector 104 can be configured to acquire images of the finger 105 of the user 101. In the following description, a camera (e.g., Webcam C500 provided by Logitech of Fremont, Calif.) is used as an example of the detector 104. In other embodiments, the detector 104 can also include an IR camera, laser detector, radio receiver, ultrasonic transducer and/or other suitable types of radio, image, and/or sound capturing component. Even though only one detector 104 is shown in FIG. 1A, in other embodiments, the electronic system 100 can include two, three, four, or any other suitable number of detectors (not shown).

The output device 106 can be configured to provide textual, graphical, sound, and/or other suitable types of feedback to the user 101. For example, as shown in FIG. 1A, the output device 106 may display a computer cursor 108 and a mail icon 111 to the user 101. In the illustrated embodiment, the output device 106 includes a liquid crystal display (“LCD”). In other embodiments, the output device 106 can also include a touch screen, an LED display, an organic LED (“OLED”) display, an active-matrix organic LED (“AMOLED”) display, a projected display, and/or other suitable displays.

The controller 118 can include a processor 120 coupled to a memory 122 and an input/output interface 124. The processor 120 can include a microprocessor (e.g., an A5 processor provided by Apple, Inc. of Cupertino, Calif.), a field-programmable gate array, and/or other suitable logic processing component. The memory 122 can include volatile and/or nonvolatile computer readable media (e.g., ROM; RAM, magnetic disk storage media; optical storage media; flash memory devices, EEPROM, and/or other suitable non-transitory storage media) configured to store data received from, as well as instructions for, the processor 120. The input/output interface 124 can include a driver for interfacing with a camera, display, touch screen, keyboard, track ball, gauge or dial, and/or other suitable types of input/output devices.

In certain embodiments, the controller 118 can be operatively coupled to the other components of the electronic system 100 via a hardwire communication link (e.g., a USB link, an Ethernet link, an RS232 link, etc.). In other embodiments, the controller 118 can be operatively coupled to the other components of the electronic system 100 via a wireless connection (e.g., a WIFI link, a Bluetooth link, etc.). In further embodiments, the controller 118 can be configured as an application specific integrated circuit, system-on-chip circuit, programmable logic controller, and/or other suitable computing framework.

In certain embodiments, the detector 104, the output device 106, and the controller 118 may be configured as a desktop computer, a laptop computer, a tablet computer, a smart phone, an electronic whiteboard, and/or other suitable types of computing devices. In other embodiments, the output device 106 may be at least a part of a television set. The detector 104 and/or the controller 118 may be integrated into or separate from the television set. In further embodiments, the controller 118 and the detector 104 may be configured as a unitary component (e.g., a game console, a camera, or a projector), and the output device 106 may include a television screen and/or other suitable displays. In further embodiments, the detector 104, the output device 106, and/or the controller 118 may be independent from one another or may have other suitable configurations.

The user 101 can operate the controller 118 in a touch free fashion by, for example, positioning, orientating, moving, and/or otherwise gesturing with the finger 105 to the electronic system 100. The electronic system 100 can monitor the user's finger gestures and correlate the gestures with computing commands, mode changes, and/or other control instructions. Techniques to determine a position, orientation, movement, and/or other gesture of the finger 105 can include monitoring and identifying a shape, color, and/or other suitable characteristics of the finger 105, as described in U.S. patent application Ser. Nos. 08/203,603 and 08/468,358, the disclosures of which are incorporated herein in their entirety.

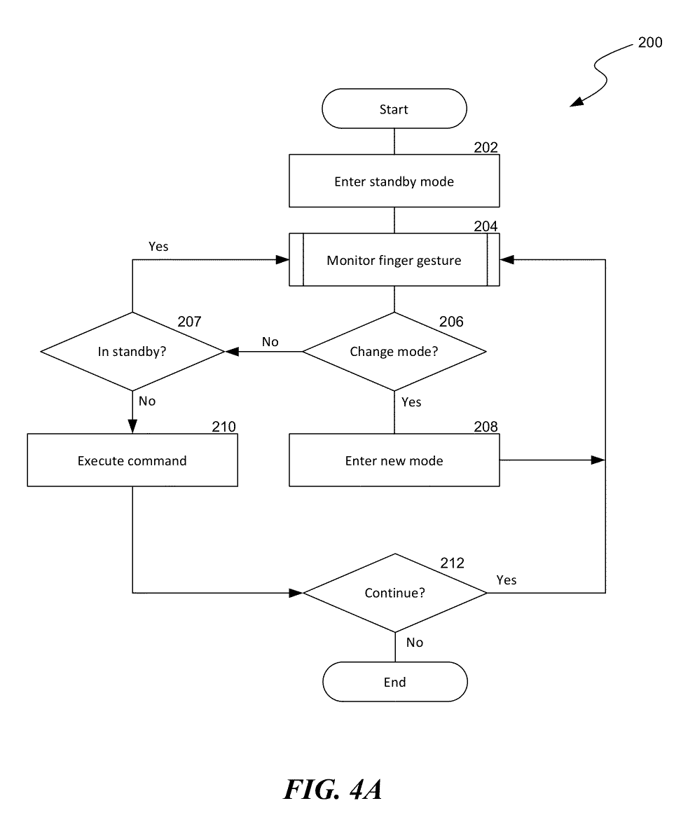

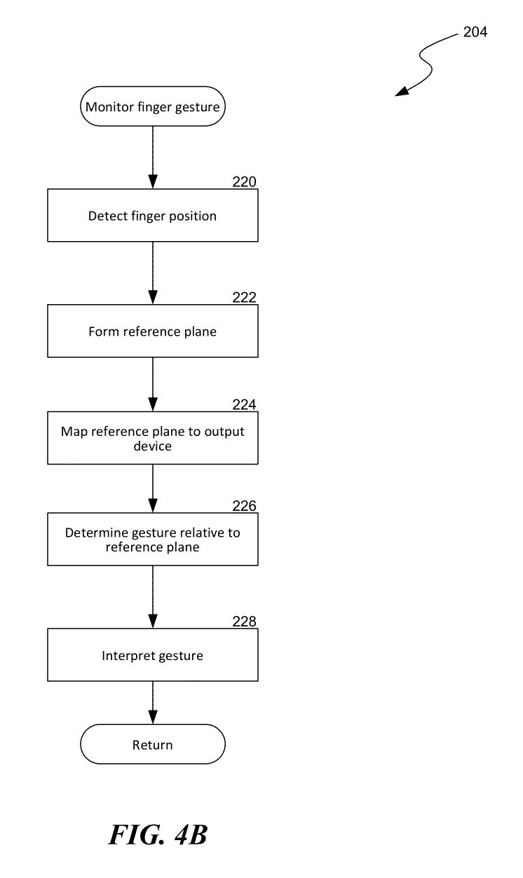

The electronic system 100 can then execute the computing commands by, for example, moving the computer cursor 108 from a first position 109a to a second position 109b. The electronic system 100 can also select and open the mail 111, or move it to a desired position on the output device 106. Details of a process suitable for the electronic system 100 are described below with reference to FIGS. 4A and 4B. Several embodiments of the electronic system 100 can thus allow the user 101 to operate computing devices in a touch free fashion with similar capabilities as conventional HMIs.

Even though the electronic system 100 in FIG. 1A is described as being configured to monitor gestures of the finger 105 directly, in other embodiments, the electronic system 100 may also include at least one object associated with the finger 105 for facilitating monitoring gestures of the finger 105. For example, as shown in FIG. 1B, the electronic system 100 can also include an input device 102 associated with the finger 105. As shown in FIG. 1B, in the illustrated embodiment, the input device 102 is configured as a ring wearable on the finger 105 of the user 101. In other embodiments, the input device 102 may be configured as a ring wearable on other fingers of the user 101. In further embodiments, the input device 102 may be configured as an open ring, a finger probe, a finger glove, a hand glove, and/or other suitable item for a finger, a hand, and/or other parts of the user 101. Though only one input device 102 is shown in FIG. 1B, in other embodiments, the electronic system 100 may include more than one and/or other suitable input devices (not shown) associated with the user 101.

In certain embodiments, the input device 102 can include at least one marker 103 (only one is shown in FIG. 1B for clarity) configured to emit a signal 110 to be captured by the detector 104. In certain embodiments, the marker 103 can be an actively powered component. For example, the marker 103 can include an LED, an OLED, a laser diode (“LDs”), a polymer light emitting diode (“PLED”), a fluorescent lamp, an infrared (“IR”) emitter, and/or other suitable light emitter configured to emit a light in the visible, IR, ultraviolet, and/or other suitable spectra. In other examples, the marker 103 can include a radio transmitter configured to emit a radio frequency (“RF”), microwave, and/or other types of suitable electromagnetic signal. In further examples, the marker 103 can include an ultrasound transducer configured to emit an acoustic signal. In yet further examples, the input device 102 can include at least one emission source configured to produce an emission (e.g., light, RF, IR, and/or other suitable types of emission). The marker 103 can include a “window” or other suitable passage that allows at least a portion of the emission to pass through. In any of the foregoing embodiments, the input device 102 can also include a power source (not shown) coupled to the marker 103 or the at least one emission source.

In other embodiments, the marker 103 can include a non-powered (i.e., passive) component. For example, the marker 103 can include a reflective material that produces the signal 110 by reflecting at least a portion of the illumination 114 from the optional illumination source 112. The reflective material can include aluminum foils, mirrors, and/or other suitable materials with sufficient reflectivity. In further embodiments, the input device 102 may include a combination of powered and passive components. In any of the foregoing embodiments, one or more markers 103 may be configured to emit the signal 110 with a generally circular, triangular, rectangular, and/or other suitable pattern. In yet further embodiments, the marker 103 may be omitted.

The electronic system 100 with the input device 102 can operate in generally similar fashion as that described above with reference to FIG. 1A, facilitated by the input device 102. For example, in one embodiment, the detector 104 can be configured to capture the emitted signal 110 from the input device 102. The processor 120 can then analyze the acquired images of the emitted signals 110 to determine a position, orientation, movement, and/or other gesture of the finger 105, as described in U.S. patent application Ser. No. 13/342,554, the disclosure of which is incorporated herein in its entirety.

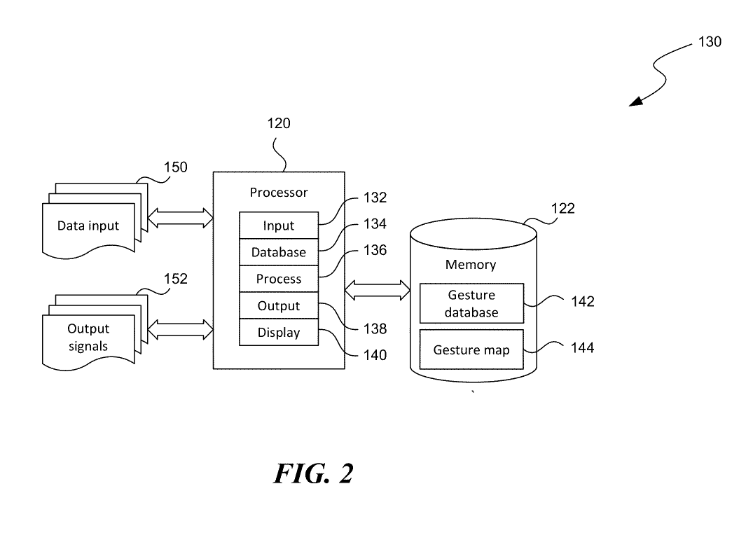

FIG. 2 is a block diagram showing computing system software modules 130 suitable for the controller 118 in FIG. 1A or 1B in accordance with embodiments of the present technology. Each component may be a computer program, procedure, or process written as source code in a conventional programming language, such as the C++ programming language, or other computer code, and may be presented for execution by the processor 120 of the controller 118. The various implementations of the source code and object byte codes may be stored in the memory 122. The software modules 130 of the controller 118 may include an input module 132, a database module 134, a process module 136, an output module 138 and a display module 140 interconnected with one another.

In operation, the input module 132 can accept data input 150 (e.g., images from the detector 104 in FIG. 1A or 1B), and communicates the accepted data to other components for further processing. The database module 134 organizes records, including a gesture database 142 and a gesture map 144, and facilitates storing and retrieving of these records to and from the memory 122. Any type of database organization may be utilized, including a flat file system, hierarchical database, relational database, or distributed database, such as provided by a database vendor such as the Oracle Corporation, Redwood Shores, Calif.

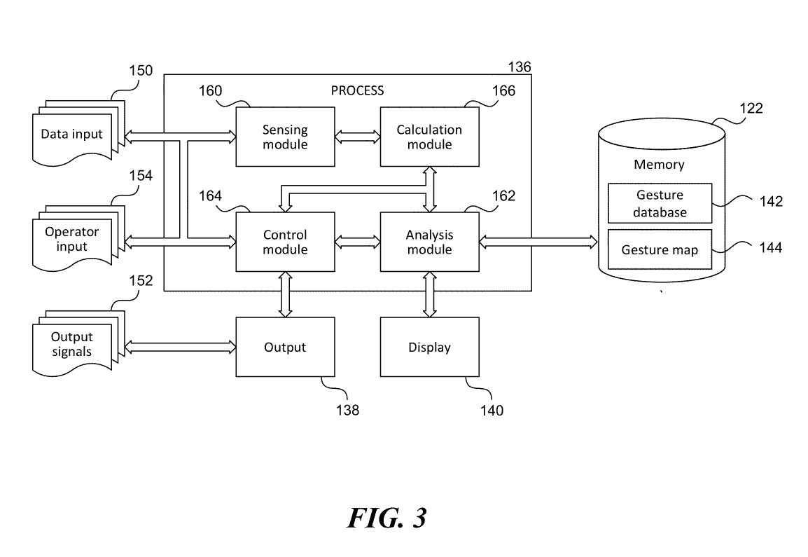

The process module 136 analyzes the data input 150 from the input module 132 and/or other data sources, and the output module 138 generates output signals 152 based on the analyzed data input 150. The processor 120 may include the display module 140 for displaying, printing, or downloading the data input 150, the output signals 152, and/or other information via the output device 106 (FIG. 1A or 1B), a monitor, printer, and/or other suitable devices. Embodiments of the process module 136 are described in more detail below with reference to FIG. 3.

FIG. 3 is a block diagram showing embodiments of the process module 136 of FIG. 2. As shown in FIG. 3, the process module 136 may further include a sensing module 160, an analysis module 162, a control module 164, and a calculation module 166 interconnected with one other. Each module may be a computer program, procedure, or routine written as source code in a conventional programming language, or one or more modules may be hardware modules.

The sensing module 160 is configured to receive the data input 150 and identify the finger 105 (FIG. 1A) and/or the input device 102 (FIG. 1B) based thereon. For example, in certain embodiments, the data input 150 includes a still image (or a video frame) of the finger 105 and/or the input device 102, the user 101 (FIG. 1A), and background objects (not shown). The sensing module 160 can then be configured to identify segmented pixels and/or image segments in the still image that correspond to the finger 105 and/or the markers 103 of the input device 102. Based on the identified pixels and/or image segments, the sensing module 160 forms a segmented image of the finger 105 and/or the markers 103 on the input device 102.

The calculation module 166 may include routines configured to perform various types of calculations to facilitate operation of other modules. For example, the calculation module 166 can include a sampling routine configured to sample the data input 150 at regular time intervals along preset directions. In certain embodiments, the sampling routine can include linear or non-linear interpolation, extrapolation, and/or other suitable subroutines configured to generate a set of data, images, frames from the detector 104 (FIG. 1A) at regular time intervals (e.g., 30 frames per second) along x-, y-, and/or z-direction. In other embodiments, the sampling routine may be omitted.

The calculation module 166 can also include a modeling routine configured to determine a position and/or orientation of the finger 105 and/or the input device 102 relative to the detector 104. In certain embodiments, the modeling routine can include subroutines configured to determine and/or calculate parameters of the segmented image. For example, the modeling routine may include subroutines to determine an angle of the finger 105 relative to a reference plane. In another example, the modeling routine may also include subroutines that calculate a quantity of markers 103 in the segmented image and/or a distance between individual pairs of the markers 103.

In another example, the calculation module 166 can also include a trajectory routine configured to form a temporal trajectory of the finger 105 and/or the input device 102. As used herein, the term “temporal trajectory” generally refers to a spatial trajectory of a subject of interest (e.g., the finger 105 or the input device 102) over time. In one embodiment, the calculation module 166 is configured to calculate a vector representing a movement of the finger 105 and/or the input device 102 from a first position/orientation at a first time point to a second position/orientation at a second time point. In another embodiment, the calculation module 166 is configured to calculate a vector array or plot a trajectory of the finger 105 and/or the input device 102 based on multiple position/orientation at various time points.

In other embodiments, the calculation module 166 can include linear regression, polynomial regression, interpolation, extrapolation, and/or other suitable subroutines to derive a formula and/or other suitable representation of movements of the finger 105 and/or the input device 102. In yet other embodiments, the calculation module 166 can include routines to compute a travel distance, travel direction, velocity profile, and/or other suitable characteristics of the temporal trajectory. In further embodiments, the calculation module 166 can also include counters, timers, and/or other suitable routines to facilitate operation of other modules.

The analysis module 162 can be configured to analyze the calculated temporal trajectory of the finger 105 and/or the input device 102 to determine a corresponding user gesture. In certain embodiments, the analysis module 162 analyzes characteristics of the calculated temporal trajectory and compares the characteristics to the gesture database 142. For example, in one embodiment, the analysis module 162 can compare a travel distance, travel direction, velocity profile, and/or other suitable characteristics of the temporal trajectory to known actions or gestures in the gesture database 142. If a match is found, the analysis module 162 is configured to indicate the identified particular gesture.

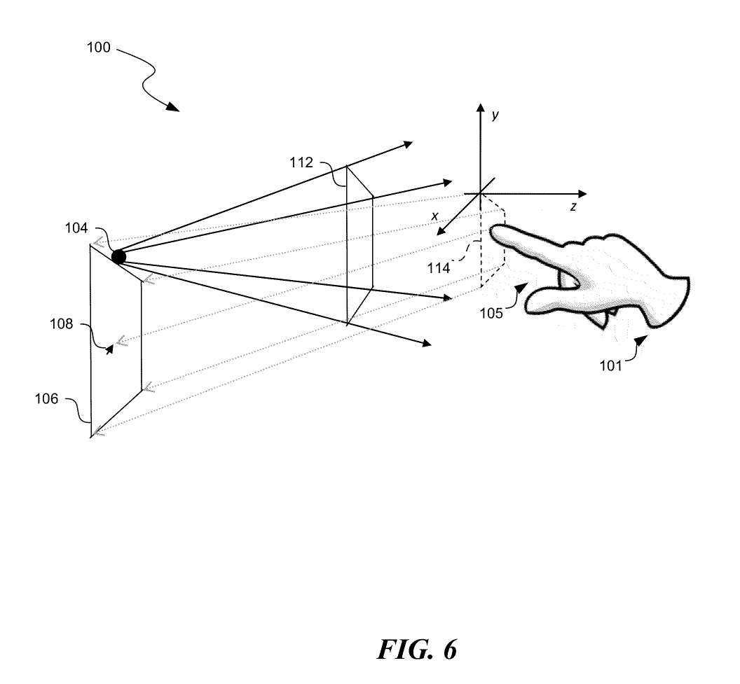

The analysis module 162 can also be configured to correlate the identified gesture to a control instruction based on the gesture map 144. For example, if the identified user action is a lateral move from left to right, the analysis module 162 may correlate the action to a lateral cursor shift from left to right, as shown in FIG. 1A. In other embodiments, the analysis module 162 may correlate various user actions or gestures with other suitable commands and/or mode change. Several examples of user gestures and corresponding control instructions are described in more detail below with reference to FIGS. 6-12B.

The control module 164 may be configured to control the operation of the controller 118 (FIG. 1A or 1B) based on the control instruction identified by the analysis module 162. For example, in one embodiment, the control module 164 may include an application programming interface (“API”) controller for interfacing with an operating system and/or application program of the controller 118. In other embodiments, the control module 164 may include a routine that generates one of the output signals 152 (e.g., a control signal of cursor movement) to the output module 138 based on the identified control instruction. In further example, the control module 164 may perform other suitable control operations based on operator input 154 (e.g., keyboard entry) and/or other suitable input. The display module 140 may then receive the determined instructions and generate corresponding output to the user 101.

FIG. 4A is a flowchart showing a process 200 for touch free operation in an electronic system in accordance with embodiments of the present technology. Even though the process 200 is described below with reference to the electronic system 100 of FIG. 1A or 1B and the software modules of FIGS. 2 and 3, the process 200 may also be applied in other electronic systems with additional and/or different hardware/software components.

Referring to FIGS. 1A, 1B, and 4A, one stage 202 of the process 200 includes initializing the electronic system 100 in standby mode. In certain embodiments, after entering standby mode, the electronic system 100 is configured to monitor for only certain gestures and ignore all other gestures and/or movements of the finger 105 or the input device 102. For example, in one embodiment, the electronic system 100 is configured to only monitor for gestures to initialize a control mode (e.g., move mode, virtual touch mode, or command mode). In other embodiments, the electronic system 100 may be configured to monitor for gestures related to additional and/or different modes.

Under the move mode, the processor 120 is configured to move a cursor displayed on the output device 106 in response to a movement of the finger 105 and/or the output device 102. Under the virtual touch mode, in one example, the processor 120 is configured to select and, optionally move, an image object (e.g., the mail 111) displayed on the output device 106 in response to a movement of the finger 105. In another example, the processor 120 may also be configured to pan a document and/or icon window displayed on the output device 106. Under the command mode, the processor 120 is configured to accept and execute computing commands (e.g., back, forward, home, single click, double click, file open, file close, print, etc.) from the user 101 in response to the determined gesture. In other embodiments, the control mode may include additional and/or different modes of operation to/from the foregoing modes.

After entering the standby mode, another stage 204 of the process 200 includes monitoring finger gestures with the detector 104. In certain embodiments, monitoring finger gestures include capturing images of the finger 105 and/or the input device 102, determining a gesture based on the captured images, and correlating the determined gesture to a user action (e.g., a computing command or a mode change). Several embodiments of monitoring finger gestures are described in more detail below with reference to FIG. 4B.

The process 200 then includes a decision stage 206 to determine if the gesture corresponds to a mode change (e.g., to initialize move mode, virtual touch mode, or command mode). If the gesture corresponds to a mode change, the process 200 proceeds to entering a new mode (e.g., one of move mode, virtual touch mode, or command mode) before reverts to monitoring finger gesture at stage 204 for computing commands.

If the gesture does not correspond to a mode change but instead a computing command, then process 200 proceeds to another decision stage 207 to determine if the process 200 is currently in standby mode. If the process 200 is in standby mode, the process 200 reverts to monitoring finger gesture at stage 204. If the process 200 is not in standby mode, the process 200 proceeds to executing the computing command at stage 210. For example, if the process 200 is currently in move mode, the process 200 may include moving the cursor 108 from the first position 109a to the second position 109b. If the process 200 is currently in virtual touch mode, the process 200 may include moving the mail 111 from its current location to a new location on the output device 106. If the process 200 is currently in command mode, the process 200 may include double click on the mail 111 to view its content.

The process 200 then includes a decision stage 212 to determine if the process 200 should continue. In one embodiment, the process is continued if further movement of the finger 105 and/or the input device 102 is detected. In other embodiments, the process 200 may be continued based on other suitable criteria. If the process is continued, the process reverts to monitoring finger gesture at stage 204; otherwise, the process ends.

FIG. 4B is a flowchart showing a process 204 for monitoring finger gesture in accordance with embodiments of the present technology. Referring to FIGS. 1A, 1B, and 4B, the process 204 includes detecting a finger position at stage 220. In one embodiment, detecting a finger position can include identifying a shape (e.g., a fingertip), color, and/or other suitable characteristics of the finger 105. In other embodiments, detecting a finger position can include identifying emitted and/or reflected signals 110 from the input device 102.

The process 204 may also include forming a reference plane based on the detected finger position at stage 222. In one embodiment, the reference plane includes an x-y plane (or a plane generally parallel thereto) in an x-y-z coordinate system based on a fingertip position of the finger 105. The reference plane can be generally parallel to the output device 106 and have a size generally corresponding to a movement range along x-, y-, and z-axis of the finger 105. In other embodiments, the reference plane may have other suitable location and/or orientation. The process 204 then includes mapping the reference plane to the output device 106. In one embodiment, the reference plane is mapped to the output device 106 based on a display size of the output device 106 (e.g., in number of pixels). As a result, the finger position in the reference plane has a corresponding position on the output device 106. In other embodiments, the reference plane may be mapped to the output device 106 in other suitable fashion.

The process 204 then includes determining a finger gesture relative to the reference plane at stage 226. In one embodiment, determining a finger gesture includes monitoring a travel distance, travel direction, velocity profile, and/or other suitable characteristics of the temporal trajectory of the finger 105 and/or the input device 102. The monitored characteristics of the temporal trajectory can then be compared with known actions or gesture in the gesture database 142 (FIG. 2). In other embodiments, determining a finger gesture may include determining other suitable position, orientation, and/or movement of the user 101.

Based on the determined gesture, the process 204 then includes interpreting the gesture at stage 228. In one embodiment, interpreting the gesture can include correlating the gesture to a computing command or mode change based on the gesture map 144 (FIG. 2). In other embodiments, interpreting the gesture can also include correlating the gesture to a control action or mode change based on other suitable conditions. The process 204 then returns with the interpreted computing command or mode change.

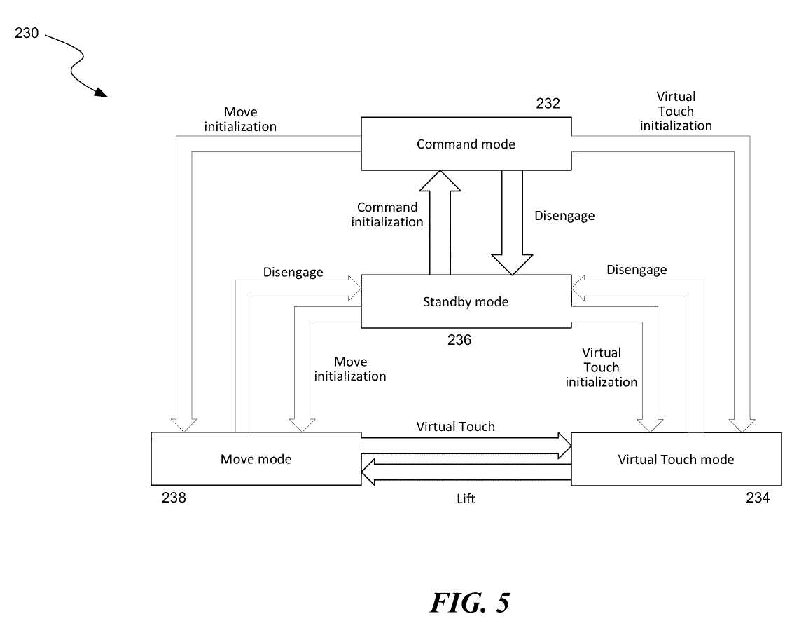

FIG. 5 is a block diagram 230 illustrating transitions amongst various control modes in accordance with embodiments of the present technology. Even though particular modes are shown in FIG. 5, in other embodiments, electronic system 100 (FIG. 1A or 1B) may have other suitable modes. As shown in FIG. 5, the electronic system 100 can include a standby mode control modes including a move mode, a virtual touch mode, and a command mode.

The electronic system 100 can transition between standby mode and the control modes with particular gestures and/or commands. For example, the electronic system 100 can transition from the standby mode to the move mode with a move initialization gesture, to the virtual touch mode with a touch initialization gesture, and to the command mode with a command initialization gesture. The electronic system 100 can also transition between control modes. For example, the electronic system 100 can transition from the move mode to the virtual touch mode with a “virtual touch” gesture and return to move mode with a “lift” gesture. In the illustrated embodiment, all the control modes can return to the standby mode with a “disengage” gesture. Example of the foregoing gestures and other gestures for computing commands and/or mode changes are discussed below with reference to FIGS. 6-12B. Even though particular gestures are discussed below, in other embodiments, additional and/or different gestures may also be used in the electronic system 100.

FIG. 6 is a schematic spatial diagram illustrating a move gesture in accordance with embodiments of the present technology. As shown in FIG. 6, the detector 104 has a field of view 112 facing a reference plane 114 based on a position of the finger 105. As discussed above, by mapping the reference plane 114 to the output device 106, the finger position (e.g., position of the fingertip) can be mapped to a position of the cursor 108 on the output device 106. Thus, when the user 101 moves the finger 105 generally parallel to the x-y plane, the electronic system 100 can move the cursor 108 accordingly. In the illustrated embodiment and in the description below, the x-y plane generally corresponds to a plane of the detector 104, and the z-axis corresponds to an axis perpendicular to the x-y plane and extending from the detector 104 toward the finger 105. In other embodiments, other suitable axis may be also be used.

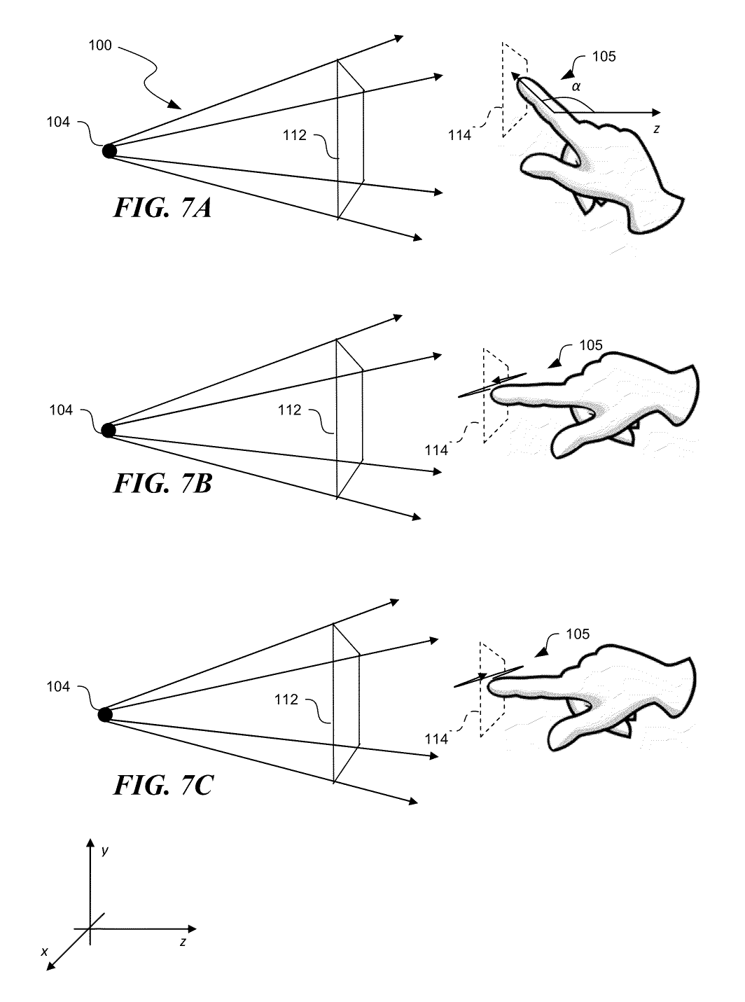

FIGS. 7A-C are schematic spatial diagrams illustrating various embodiments of move initialization gestures in accordance with embodiments of the present technology. As shown in FIG. 7A, in one embodiment, a move initialization gesture can include that the finger 105 forms an angle of less than 180 degrees with respect to the z-axis and remains generally steady for a predetermined period of time (e.g., 0.5 seconds). As shown in FIG. 7B, in another embodiment, a move initialization gesture can include that the finger 105 moves back and forth along the x-axis for a predetermined number of repetitions (e.g., 3 times), with a first move starts toward a direction generally parallel to the positive direction of x-axis. As shown in FIG. 7C, in a further embodiment, a move initialization gesture can include that the finger 105 moves back and forth along a direction generally parallel to the x-axis for a predetermined number of repetitions (e.g., 3 times), with a first move starts toward a direction generally parallel to the negative direction of x-axis.

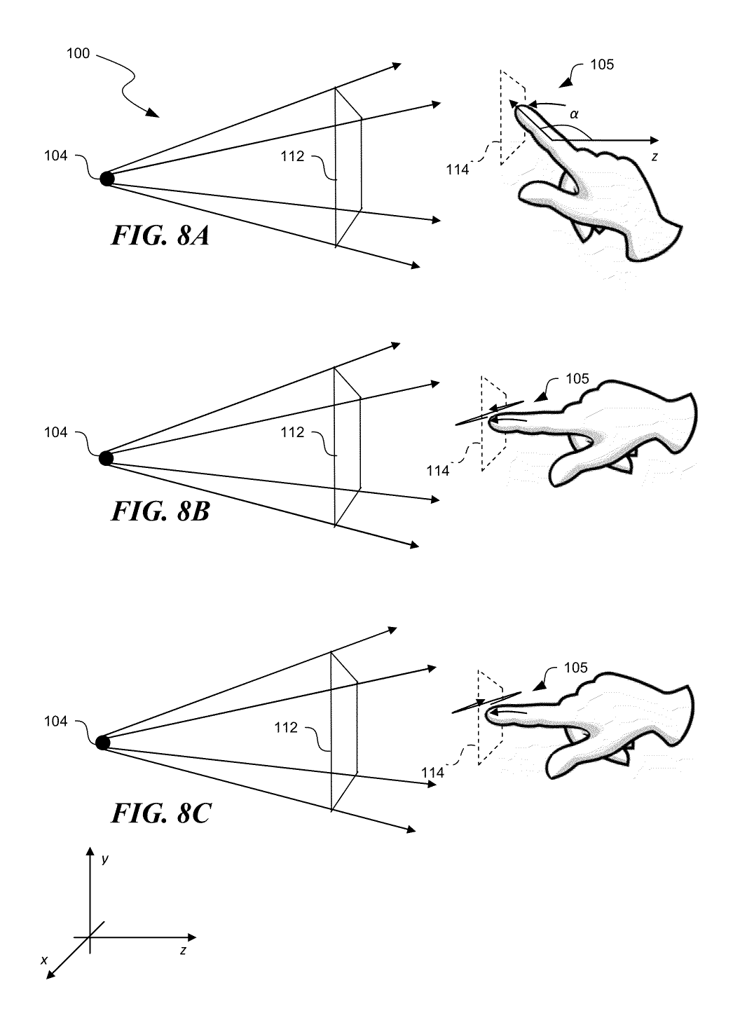

FIGS. 8A-C are schematic spatial diagrams illustrating various embodiments of virtual touch initialization gestures in accordance with embodiments of the present technology. As shown in FIG. 8A, in one embodiment, a virtual touch initialization gesture can be that the finger 105 forms an angle of less than 180 degrees with respect to the z-axis and moves toward the detector 104 along a direction generally parallel to the negative direction of z-axis. The finger 105 then generally maintains its position and orientation for a predetermined period of time. As shown in FIG. 8B, in another embodiment, a virtual touch initialization gesture can be that the finger 105 moves toward the detector 104 along a direction generally parallel to the negative direction of z-axis and then moves back and forth along a direction generally parallel to the x-axis for a predetermined number of repetitions (e.g., 3 times). The first move starts toward a direction generally parallel to the positive direction of x-axis. As shown in FIG. 8C, in a further embodiment, a virtual touch initialization gesture can be that the finger 105 moves toward the detector 104 along a direction generally parallel to the negative direction of z-axis and then moves back and forth along a direction generally parallel to the x-axis for a predetermined number of repetitions (e.g., 3 times). The first move starts toward a direction generally parallel to the positive direction of x-axis. The first move starts toward the positive direction of x-axis.

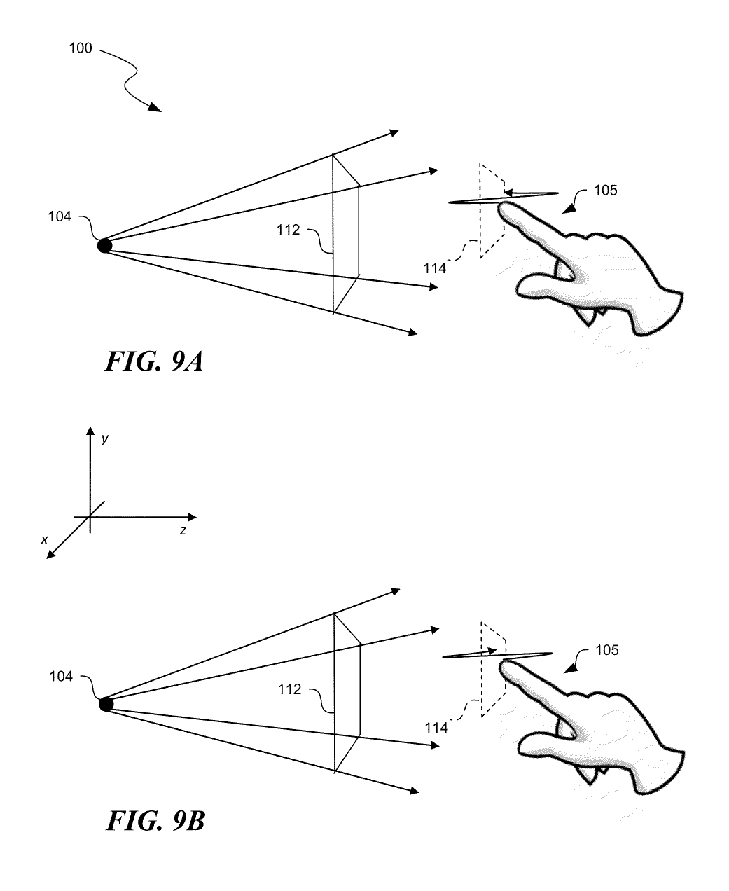

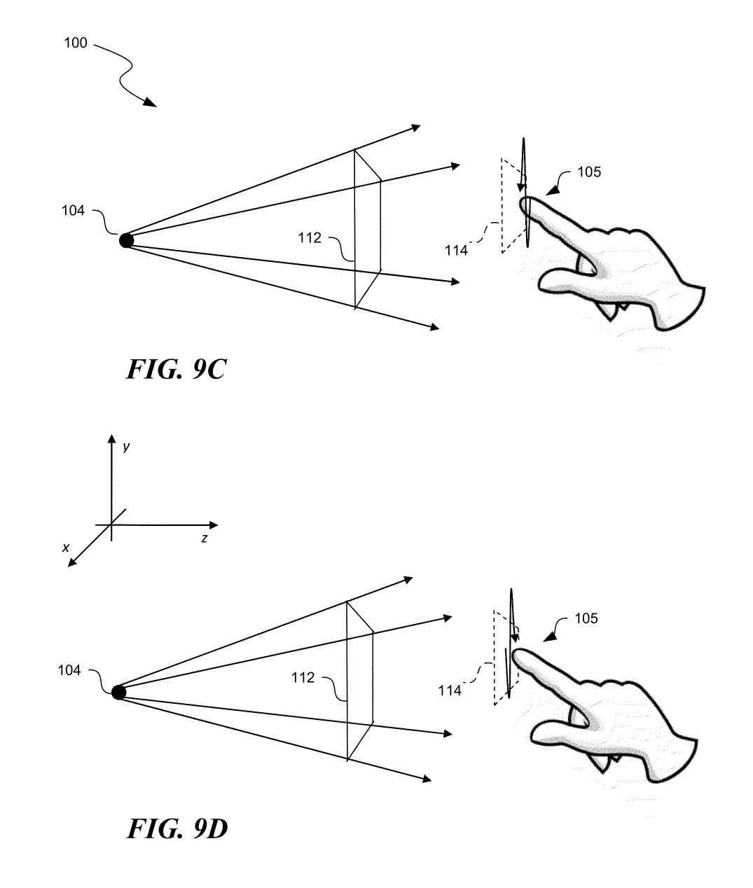

FIGS. 9A-D are schematic spatial diagrams illustrating various embodiments of command initialization gestures in accordance with embodiments of the present technology. As shown in FIG. 9A, in one embodiment, a command initialization gesture can include that the finger 105 moves back and forth along a direction generally parallel to the z-axis for a predetermined number of repetitions (e.g., 3 times), with the first move starts toward a direction generally parallel to the positive direction of z-axis. As shown in FIG. 9B, in another embodiment, a command initialization gesture can include that the finger 105 moves back and forth along a direction generally parallel to the z-axis for a predetermined number of repetitions (e.g., 3 times), with the first move starts toward a direction generally parallel to the negative direction of z-axis. In other embodiments, a command initialization gesture can include that the finger 105 moves back and forth along a direction generally parallel to the y-axis for a predetermined number of repetitions (e.g., 3 times), with the first move starts toward a direction generally parallel to either the positive or negative direction of y-axis, as shown in FIGS. 9C and 9D, respectively. In further embodiments, a command initialization gesture can include other suitable gestures.

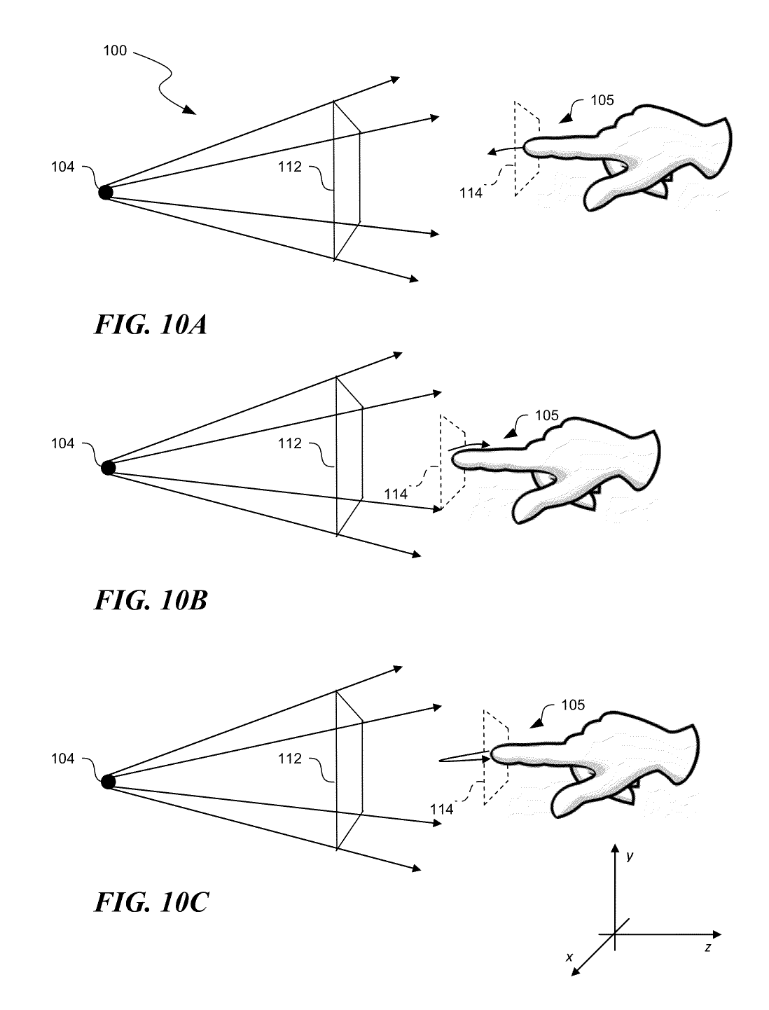

FIGS. 10A-C are schematic spatial diagrams illustrating additional gestures in accordance with embodiments of the present technology. As shown in FIG. 10A, in one embodiment, a “virtual touch” gesture can include that the finger 105 moves toward the detector 104 along a direction generally parallel to the negative direction of the z-axis from the reference plane 114 and/or along a current direction of the finger 105. A speed of the finger motion is greater than a speed threshold, and an x-y plane motion (i.e., a motion generally parallel to the x-y plane) is lower than a plane threshold. As shown in FIG. 10B, in another embodiment, a “disengage” gesture can include that the finger 105 moves away from the detector 104 for a distance greater than a threshold. In a further embodiment, if the distance is not greater than the threshold, the movement may correspond to a “lift” gesture. As shown in FIG. 10C, in yet another embodiment, a “tap” gesture can include the finger 105 moves toward the detector 104 and then away for approximately same distance.

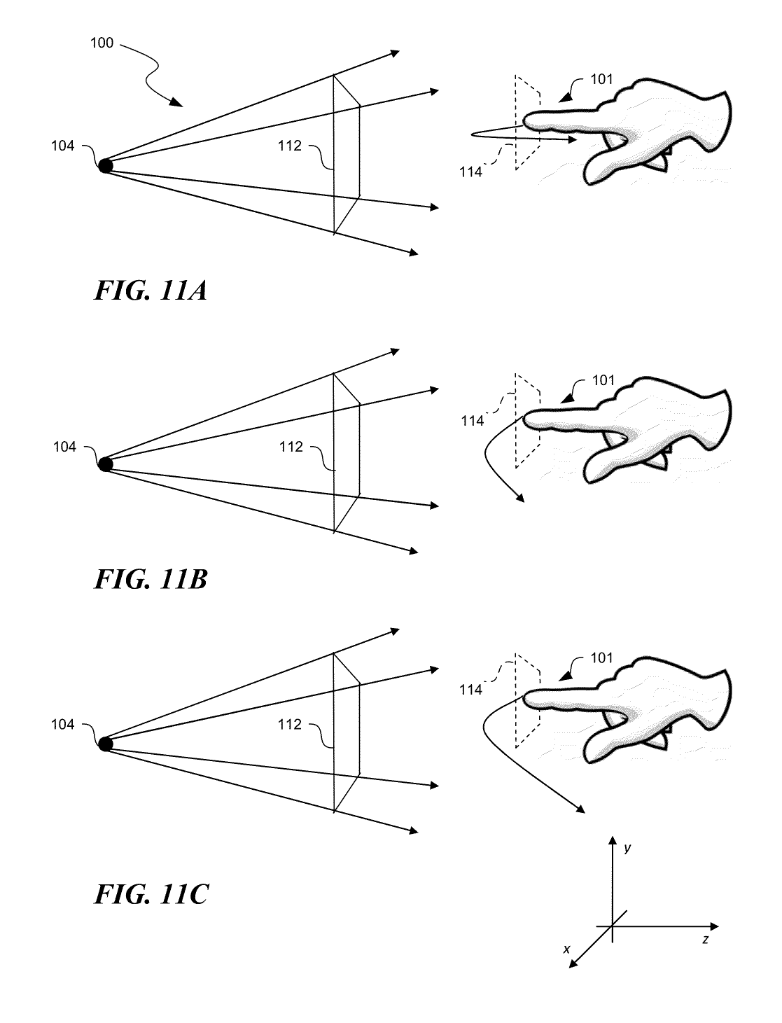

Movement by the finger 105 can also be interpreted as a combination of computing commands and/or mode changes. For example, FIGS. 11A-C are schematic spatial diagrams illustrating various embodiments of further gestures in accordance with embodiments of the present technology. As shown in FIG. 11A, when the finger 105 moves toward the detector 104 along a direction generally parallel to the negative direction of z-axis and then away along the opposite direction for a distance substantially greater than the distance travelled toward the detector 104 within a predetermined period of time, then the movement can be correlated to a combination of “tap” and “disengage” gestures. As shown in FIG. 11B, a “swipe” gesture can include the finger 105 moves generally parallel to the x-y plane along any directions. As shown in FIG. 11C, if the finger 105 is substantially away from the detector 104 at the end of the movement, the movement can be correlated to a combination of “swipe” and “disengagement” gestures.

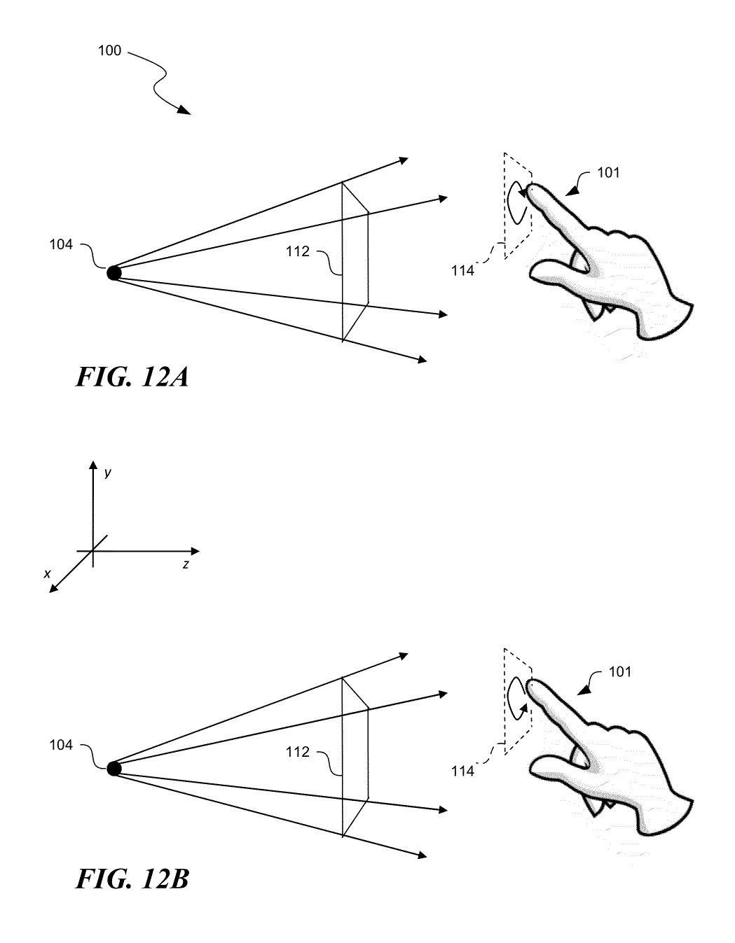

FIGS. 12A and 12B are schematic spatial diagrams illustrating various embodiments of rotation and/or zooming gestures in accordance with embodiments of the present technology. As shown in FIG. 12A, a “clockwise rotation” gesture can include the finger 105 drawing generally a circle generally parallel to the x-y plane in a clockwise direction. As shown in FIG. 12B, a “counter-clockwise rotation” gesture can include the finger 105 drawing generally a circle generally parallel to the x-y plane in a counter clockwise direction. Even though the various gestures in FIGS. 6-12B are discussed with reference to the finger 105, in other embodiments, the various gestures can also be based on a position, orientation, and/or movement of the input device 102 (FIG. 1B) or a combination of the finger 105 and the input device 102.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method implemented in a computing device having a processor, a camera, and a display operatively coupled to one another, the method comprising:
acquiring an image of a user's finger or an object associated with the user's finger with the camera, the user's finger or the object being spaced apart from the display;
with the processor,
recognizing a gesture of the user's finger or the object based on the acquired image;
determining if the recognized gesture correlates to a command or a mode change for the processor;
if the monitored gesture correlates to a command for the processor,
determining if the processor is currently in a standby mode or in a control mode; and
if the processor is in the control mode, executing the command for the processor; else if the processor is in the standby mode, reverting to monitoring a gesture of the user's finger or the object associated with the user's finger.

2. The method of claim 1, further comprising initializing the processor in the standby mode prior to acquiring the image of the user's finger or the object associated with the user's finger with the camera.

3. The method of claim 1, further comprising if the monitored gesture correlates to a mode change, entering the processor in the control mode from the standby mode and reverting to acquiring the image of the user's finger or the object.

4. The method of claim 1, further comprising:
if the monitored gesture correlates to a mode change,
entering the processor in the control mode from the standby mode and reverting to acquiring an image of the user's finger or the object;
wherein the control mode includes one of a move mode, a virtual touch mode, and a command mode, and wherein
under the move mode, the processor is configured to move a cursor on the display of the computing device in response to a movement of the user's finger or the object;
under the virtual touch mode, the processor is configured to select and, optionally move, an object displayed on the display of the computing device in response to a movement of the user's finger or the object; and
under the command mode, the processor is configured to accept and execute computing commands from the user in response to the recognized gesture.

5. The method of claim 4, further comprising if the monitored gesture correlates to a mode change, returning the processor from one of the move mode, virtual touch mode, and command mode to the standby mode.

6. The method of claim 4 wherein:
the move mode corresponds to a move initialization gesture;
the virtual touch mode corresponds to a virtual touch initialization gesture;
the command mode corresponds to a command initialization gesture;
the move initialization gesture, the virtual touch initialization gesture, and the command initialization gesture are different from one another;
the standby mode correspond to a disengage gesture; and
the disengage gesture is the same for the move mode, the virtual touch mode, and the command mode.

7. The method of claim 1 wherein:
the camera includes a field of view;
the method further includes
determining if the user's finger or the object is in the field of view of the camera,
if the user's finger or the object is not in the field of view of the detector, returning the processor from the control mode to the standby mode.

8. A method implemented in a computing device having a processor, a detector, and a display operatively coupled to one another, the method comprising:
acquiring images of a user's finger or an object associated with the user's finger with the detector, the user's finger or the object being spaced apart from the display of the computing device;
with the processor,
determining a position of the user's finger or the object based on the acquired images;
forming a reference plane based on the determined position, the reference plane being generally parallel to the display of the computing device;
correlating a temporal trajectory of the user's finger or object to a command for the processor, the temporal trajectory being relative to the reference plane; and
executing the command for the processor.

9. The method of claim 8, further comprising:
mapping the position of the user's finger or the object relative to the reference plane to the display of the computing device; and
correlating the mapped position of the user's finger or the object to a cursor on the display of the computing device.

10. The method of claim 8, further comprising:
defining a three-dimensional coordinate system having x-, y-, and z-axis based on the determined position of the user's finger or the object with the reference plane located generally parallel to the x-y plane;
wherein correlating the temporal trajectory includes if
the user's finger or the object forms an angle of less than 180 degrees relative to the z-axis and remains generally stationary for a predetermined period of time, or
the user's finger or the object moves back and forth along x-axis for a predetermined number of repetitions, then
interpreting the temporal trajectory as initializing a move mode.

11. The method of claim 8, further comprising:
defining a three-dimensional coordinate system having x-, y-, and z-axis based on the determined position of the user's finger or the object with the reference plane located generally parallel to the x-y plane;
wherein correlating the temporal trajectory includes if
the user's finger or the object forms an angle of less than 180 degrees relative to the z-axis and moves toward the display of the computing device, or
the user's finger or the object moves toward the display of the computing device and then moves back and forth along x-axis for a predetermined number of repetitions, then
interpreting the temporal trajectory as initializing a virtual touch mode.

12. The method of claim 8, further comprising:
defining a three-dimensional coordinate system having x-, y-, and z-axis based on the determined position of the user's finger or the object with the reference plane located generally parallel to the x-y plane; and
wherein correlating the temporal trajectory includes if the user's finger or the object moves back and forth along y-axis for a predetermined number of repetitions, then interpreting the temporal trajectory as initializing a command mode.

13. The method of claim 8, further comprising:
defining a three-dimensional coordinate system having x-, y-, and z-axis based on the determined position of the user's finger or the object with the reference plane located generally parallel to the x-y plane; and
wherein correlating the temporal trajectory includes if the user's finger or the object moves toward the display of the computing device along z-axis with a speed greater than a speed threshold and a x-y plane motion lower than a plane threshold and then remains generally stationary for a predetermined period of time, then interpreting the temporal trajectory as a virtual touch.

14. The method of claim 8, further comprising:
defining a three-dimensional coordinate system having x-, y-, and z-axis based on the determined position of the user's finger or the object with the reference plane located generally parallel to the x-y plane; and
wherein correlating the temporal trajectory includes
if the user's finger or the object moves toward the display of the computing device along z-axis with a speed greater than a speed threshold and a x-y plane motion lower than a plane threshold and then remains generally stationary for a predetermined period of time, then interpreting the temporal trajectory as a virtual touch;
subsequently, if the use's finger or the object moves away from the display of the computing device for a distance,
if the distance is greater than a threshold, interpreting the temporal trajectory as entering a standby mode; and
if the distance is not greater than the threshold, interpreting the temporal trajectory as removing the virtual touch.

15. The method of claim 8, further comprising:
defining a three-dimensional coordinate system having x-, y-, and z-axis based on the determined position of the user's finger or the object with the reference plane located generally parallel to the x-y plane; and
wherein correlating the temporal trajectory includes if the user's finger or the object moves toward the display of the computing device for a forward distance and subsequently moves away for a backward distance along z-axis within a predetermined period of time, and the forward distance is generally equal to the backward distance, then interpreting the temporal trajectory as a tap.

16. The method of claim 8, further comprising:
defining a three-dimensional coordinate system having x-, y-, and z-axis based on the determined position of the user's finger or the object with the reference plane located generally parallel to the x-y plane; and
wherein correlating the temporal trajectory includes if the user's finger or the object moves toward the display of the computing device for a forward distance and subsequently moves away for a backward distance along z-axis, and the forward distance is less than the backward distance, then interpreting the temporal trajectory as a tap and subsequently entering a standby mode.

17. A computing device, comprising:
a display;
a detector configured to acquiring an image of a user's finger or an object associated with the user's finger spaced apart from the display;
a processor operatively coupled to the display and detector; and
a non-transitory computer readable medium storing instructions, when executed by the processor, causing the processor to perform a process including:
receiving the acquired image from the detector;
determining a position of the user's finger or the object based on the acquired image;
forming a reference plane based on the determined position, the reference plane being generally parallel to the display; and
correlating a gesture of the user's finger or object to a command for the processor or a mode change, the gesture corresponding to at least one of a position, orientation, and movement of the user's finger or the object relative to the reference plane;
determining if the correlated gesture is a command for the processor or a mode change;
if the monitored gesture is a command for the processor, determining if the processor is currently in a standby mode or in a control mode; and
if the processor is in a control mode, executing the command for the processor; else, reverting to receiving the acquired image of the user's finger or the object associated with the user's finger.

18. The computing device of claim 17 wherein the process further includes:
defining a three-dimensional coordinate system having x-, y-, and z-axis based on the determined position of the user's finger or the object with the reference plane located generally parallel to the x-y plane; and
if the gesture includes the user's finger or the object moves toward the display of the computing device along z-axis with a speed greater than a speed threshold and a x-y plane motion lower than a plane threshold and then remains generally stationary for a predetermined period of time, correlating the gesture to a virtual touch command.

19. The computing device of claim 17 wherein:
correlating the gesture includes correlating the gesture of the user's finger or object to a mode change, and if the processor is currently in the standby mode,
entering in a control mode from the standby mode, the control mode being one of a move mode, a virtual touch mode, and a command mode, and wherein
under the move mode, the processor is configured to move a cursor on the display of the computing device in response to a movement of the user's finger or the object;
under the virtual touch mode, the processor is configured to select and, optionally move, an object displayed on the display of the computing device in response to a movement of the user's finger or the object; and
under the command mode, the processor is configured to accept and execute computing commands from the user in response to the recognized gesture.

20. The computing device of claim 17 wherein:
the detector includes a field of view; and
the process further includes
determining if the user's finger or the object is in the field of view of the detector,
if the user's figure or the object is not in the field of view of the detector, returning the processor from the control mode to the standby mode.
